(19) United States
(12) Patent Application Publication
(10) Pub. No.: US 2017/0120758 A1
(43) Pub. Date: May 4, 2017

(54) V2X BASED WIRELESS CHARGING METHOD AND APPARATUS FOR VEHICLES

(71) Applicant: LEAUTO INTELLIGENT TECHNOLOGY (BEIJING) CO.LTD, Beijing (CN)

(72) Inventors: Yong XU, Beijing (CN); Wenrui LI, Beijing (CN); Wei LIN, Beijing (CN); Yu ZOU, Beijing (CN); Xiaofei GOU, Beijing (CN); Peng LIU, Beijing (CN); Dan LI, Beijing (CN)

(21) Appl. No.: 14/972,037

(22) Filed: Dec. 16, 2015

(30) Foreign Application Priority Data
Nov. 2, 2015 (CN) 201510736533.0

(51) Int. Cl. B60L 11/18

(52) U.S. Cl. CPC B60L 11/182; B60L 11/1837; B60L 11/1846; B60L 11/1844; B60L 11/1861; B60L 2230/10

(57) ABSTRACT

The embodiment of the disclosure is related to a V2X based wireless charging method and apparatus for vehicles. The method involves obtaining vehicle information of the vehicle when the vehicle outputting a wireless charging request; wherein the vehicle information comprises: an unique identification number of the vehicle and a license plate of the vehicle; determining whether the vehicle conforms to a predetermined charging condition according to the unique identification number of the vehicle and the license plate of the vehicle; receiving a wireless charging request command and turning on a charging power source if the vehicle conforms to the predetermined charging condition; wherein the predetermined charging condition comprises a vehicle type and whether an identify of the vehicle matches with a current wireless charger. The wireless charging progress of the intelligent vehicle and promoting vehicles using new energy are achieved.

### CROSS-REFERENCE TO RELATED APPLICATIONS

This application claims priority under 35 U.S.C. §119(a) to Patent Application No(s). 201510736533.0, filed in China on Nov. 2, 2015, the entire contents of which is hereby incorporated by reference.

### FIELD OF TECHNICAL

The disclosure relates to a field of wireless charging, and more particular to V2X based wireless charging method and apparatus for vehicles.

### BACKGROUND

People cannot but deliberate about the sustainable development of the automotive industry with the increasing consumption of non-renewable resources, especially oil resources consumption. Development of vehicles using new energy will become the mainstream development of vehicles. City construction will consider the establishment of additional charging devices such as charging station and charging pile in order to promote pure electric vehicles, extended range electric vehicles, plug-in hybrid vehicles and fuel cell electric vehicles and other vehicles using new energy.

In recent years, the wireless charging technology is gradually into people's vision. The wireless charging technology is originated from wireless power transmission technology. Wireless charging, also known as inductive charging or non-contact inductive charging, uses near field induction, which is an inductive coupling. The power sourcing equipment (charger) transfers the energy to the powered device. The apparatus uses the received energy to charge a battery and for its own functioning at the same time. The charger and the powered device can have no exposed conductive contacts because the energy is transferred by the inductive coupling between the charger and the powered device without cable connecting. In addition, wireless charging technology is different from the traditional wired charging, adapted to a wider range without charging piles and cables, and the wireless charging technology has no electric shock risk.

There are a few pilot applications of the wireless charging technology in electric buses in some cities, but the functionality is limited to wireless charging. After the popularity of electric vehicles in the future, wireless chargers will be as municipal infrastructures. Wireless charging for different types of vehicles needs to be considered. The municipal building planners need to think about the quantities and the locations for wireless chargers to maximize its convenience. If the identity of the vehicle, controlling of charging power, recording of vehicle tracks and other service information can be obtained during the wireless charging, that would have a positive role for the promotion of wireless charging technology and the construction of city infrastructure.

### SUMMARY

The present disclosure provides a V2X based wireless charging method and apparatus to solve the wireless charger defects of functional limitation and achieve the personalized matching between the wireless chargers and charging vehicles. The construction of intelligent roads is achieved according to the vehicles track data and the popularization of electric vehicles is promoted at the same time.

One embodiment of the disclosure provides a method for wirelessly charging a vehicle based on V2X. The method comprises:
obtaining vehicle information of the vehicle when the vehicle outputs a wireless charging request; wherein the vehicle information comprises: a unique identification number of the vehicle and a license plate of the vehicle; and
determining whether the vehicle conforms to a predetermined charging condition according to the unique identification number of the vehicle and the license plate of the vehicle; and receiving a wireless charging request command and turning on a charging power source if the vehicle conforms to the predetermined charging condition; wherein the predetermined charging condition comprises a vehicle type and whether an identify of the vehicle matches with a current wireless charger.

One embodiment of the disclosure provides an apparatus of wirelessly charging a vehicle based on V2X. The apparatus comprises:
a V2X communication module configured to obtain vehicle information of the vehicle when the vehicle outputs a wireless charging request; wherein the vehicle information comprises: a unique identification number of the vehicle and a license plate of the vehicle; and
a CPU configured to determine whether the vehicle conforms to a predetermined charging condition according to the unique identification number of the vehicle and the license plate of the vehicle; and receiving a wireless charging request command and turning on a charging power source if the vehicle conforms to the predetermined charging condition; wherein the predetermined charging condition comprises a vehicle type and information whether an identify of the vehicle matches with a current wireless charger.

The embodiments of the disclosure provide a V2X based wireless charging method and apparatus. Through the information acquisition of vehicles charging requests, the wireless charger defects of functional limitation in prior art is solved. The personalized matching between the wireless chargers and charging vehicles and the automation in the charging process are achieved. The construction of intelligent roads is achieved according to the vehicles track data, the popularization of electric vehicles is promoted, and the contribution for the sustainable development of the automotive industry is made.

### BRIEF DESCRIPTION OF THE DRAWINGS

In order to illustrate the technical schemes of the prior art or the embodiments of the disclosure more clearly, the accompanying drawings for illustrating the prior art or the embodiments of the disclosure are briefly described as below. It is apparent that the drawings described below are merely some embodiments of the disclosure, and those skilled in the art may derive other drawings according the drawings described below without creative endeavor.

FIG. 1 is a technical flow chart according to first embodiment of the present disclosure;

FIG. 2 is the technical flow chart according to second embodiment of the present disclosure;

FIG. 3 is the schematic diagram for the apparatus according to third embodiment of the present disclosure; and

FIG. 4 is the schematic diagram of the interaction between the apparatus and the technical flow chart according to the forth embodiment of the present disclosure.

### DESCRIPTION OF THE EMBODIMENTS

For the purpose, technical solution, and advantage of the disclosure becoming clearer, the specific embodiments of the disclosure combined with the accompanying drawings to clearly and completely are described as follows. Obviously, the described embodiments are only part of the embodiments of the disclosure rather than all embodiments. Based on the embodiments of the disclosure all other embodiments obtained by those having ordinary skills in this field without creative work are within the scope of protection of the disclosure.

The core of the embodiment of the present disclosure is that obtaining vehicle information of the vehicle when the vehicle outputs a wireless charging request; wherein the vehicle information comprises: a unique identification number of the vehicle and a license plate of the vehicle; determining whether the vehicle conforms to a predetermined charging condition according to the unique identification number of the vehicle and the license plate of the vehicle; and receiving a wireless charging request command and turns on a charging power source if the vehicle conforms to the predetermined charging condition; wherein the predetermined charging condition comprises a vehicle type information and whether an identify of the vehicle matches with a current wireless charger. If the vehicle information comprises a vehicle driving route, a data supporting to a construction of wireless charger according to the analysis of the vehicle driving route of each vehicle is provided.

### First Embodiment

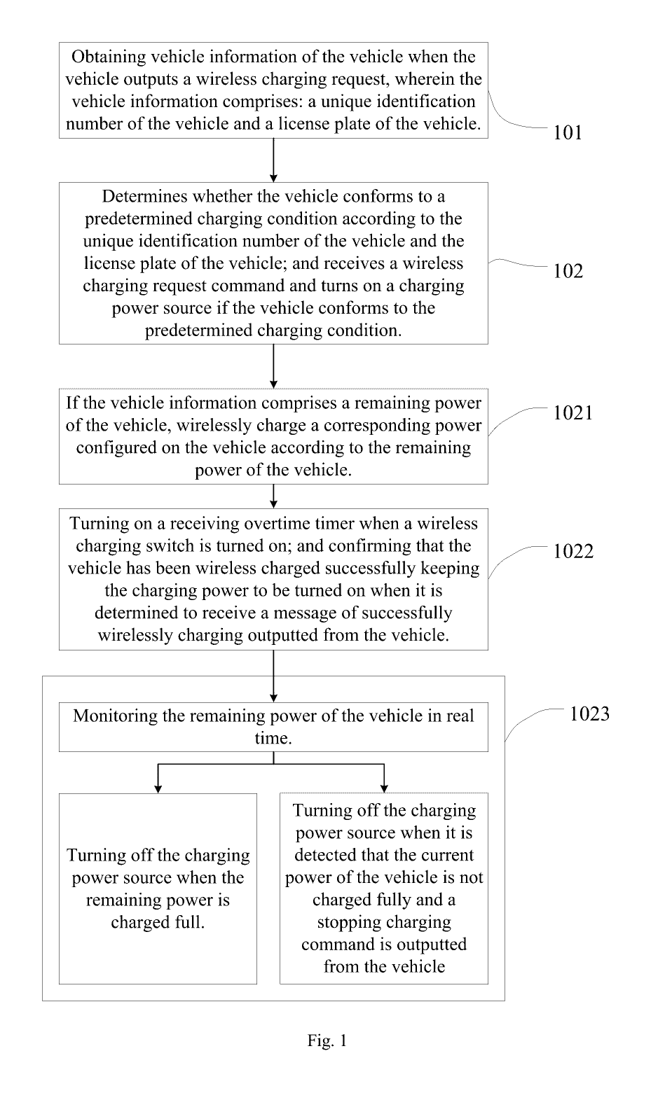

FIG. 1 is a technical flow chart according to first embodiment of the present disclosure. In conjunction with FIG. 1, the present disclosure is a method for wirelessly charging a vehicle based on V2X and achieved by following steps:

Step 101: obtaining vehicle information of the vehicle when the vehicle outputs a wireless charging request; wherein the vehicle information comprises: a unique identification number of the vehicle and a license plate of the vehicle.

V2X is used for the vehicular communication technology to obtain the vehicle information of the vehicle in the embodiment of the disclosure. V2X technology is in line with the basic principles of IEEE802.11p communication protocols. The technology is applied on the vehicle electronics and the vehicle communication and made the communication between vehicles and vehicles, vehicles and base stations, or base stations and base stations. Therefore, the real-time traffic, road information, pedestrian information and other series of traffic information can be obtained. Increasing driver safety, reducing congestion, improving traffic efficiency and providing vehicle entertainment information are achieved.

Step 102: determines whether the vehicle conforms to a predetermined charging condition according to the unique identification number of the vehicle and the license plate of the vehicle; receives a wireless charging request command and turns on a charging power source if the vehicle conforms to the predetermined charging condition; wherein the predetermined charging condition comprises a vehicle type and whether an identify of the vehicle matches with a current wireless charger.

Electric vehicle charging stations will become the focal point of the automotive industry and the energy industry with the popularity of electric vehicles. Meanwhile, the private wireless chargers also need to determine whether the vehicle requesting charging is allowed to charge, in order to ensure safety and ordered use of wireless charges as private parking lots or private parking areas determine whether parking is allowed according to the license plate. In the embodiment of the disclosure, obtaining the license plate of the vehicle requested charging power through V2X technology may determine the identity of the vehicle, thereby achieving the strict management of wireless charger.

In addition, the wireless chargers need to further determine whether the vehicle matches the type of rechargeable vehicle for different types of vehicles. For example, the pure electric vehicles can only be charged by a particular wireless charging station. The charging type or the charging voltage of hybrid vehicles or other type electric vehicles cannot be matched. Thus this would result in failure on charging or security risks due to improperly charging. Therefore, in one embodiment of the disclosure, the information of the vehicles requesting charging through the V2X technology before charging is obtained to identify in advance whether the charging type of vehicle matches with the current wireless charger, thereby increasing the efficiency of wireless charger.

In step 102, the receiving a wireless charging request command and turning on a charging power source further comprises the following step 1021 to step 1023.

Step 1021: If the vehicle information comprises a remaining power of the vehicle, wirelessly charge a corresponding power configured on the vehicle according to the remaining power of the vehicle.

In one embodiment of the disclosure, the wireless charger directly communicates with the vehicle. When the vehicle requests to charge, the wireless charger obtains the remaining power of the vehicle from the vehicle information, automatically calculates the power needed to charge the vehicle and configures the appropriate power. When a plurality of vehicles charges at the same time, it may determine the power needed for each vehicle in advance such that controlling and deploying the electric energy resource can be achieved.

The current wireless charging technology mainly depends on the principle and implementation of electromagnetic coupling, photo coupling, and electromagnetic resonance.

The principle of electromagnetic coupling refers to the phenomena that there is a close cooperation with the interaction between the input and output of two or more circuit elements or electrical networks, and the energy is transferred from one side to the other side through interaction. Changing electric field produces a magnetic field and changing magnetic field becomes the electric field again.

The principle of photo coupling refers that the electrical energy is transformed into light, such as laser light. The energy is passed to the destination and transferred into electrical energy through the light. Such wireless charging technology is intuitively and the photoelectric conversion technology is also widely used. The transference path of the light has the disadvantage that the transmission path cannot have obstacles. The principle of the electromagnetic resonance is similar to the acoustic resonance. Two media have the same resonance frequency which can be used to transfer energy.

Wireless chargers charges mainly adopts the wireless charging coil. Direct current cannot form an alternating magnetic field. Therefore, the wireless charging can only adopt alternating current to charge. The alternating current is typically 220V AC power.

There are no exposed connectors for wireless charging of the electric vehicles. The security risk of electric leakage is completely avoided. The power source and the transformer can be hided under the ground by adopting the wireless charging. Vehicles can be charged at parking lots or special charging points on street.

The wireless charging coil is embedded in the interior of the road beneath the parking spaces, or adhered on the road surface by pasting. The thickness of the wireless charging coil does not determine that the charging effect is good or bad because the principle of wireless charging is the electromagnetic coupling between the coil on the road surface and the wireless charging coil of the vehicle. The charging effect is determined by the electromagnetic strength and the coil area. In general, the charging coil may have the thickness as low as 2 cm. The wireless charging coil adhered on the road surface is entirely feasible. The wireless charging coil directly connects to the alternating current power source. The charging source of the alternating current power source is installed with a switch controlled by the CPU (central processing unit).

Step 1022: turning on a receiving overtime timer when a wireless charging switch is turned on; and confirming that the vehicle has been wireless charged successfully and keeping the charging power to be turned on when it is determined to receive a message of successfully wirelessly charging outputted from the vehicle.

Step 1023: monitoring the remaining power of the vehicle in real time and turning off the charging power source when the remaining power is charged full.

In addition, it is worth noting that the power of vehicle does not reach 100% and request to stop charging during the process of wireless charging due to the limitation of external factors. The charging power source is turned off when it is detected that the current power of the vehicle is not charged fully as well as outputting a stopping charging command from the vehicle. Thus a user controllable charging process is achieved.

In one embodiment, through the communication between the vehicle and the wireless charging station, it actively obtains the vehicle type and the identity of the vehicle of each vehicle requesting charging and determines whether the predetermined charging condition is confirmed. The promotion of wireless charger and the popularity of electric vehicles are promoted. The safety and the efficiency of wireless charger is increased. During the charging process, the remaining power of the vehicle is monitored in real time and the regulation of power resources as well as active power protection are achieved in order to provide better experience of wireless charging to electric vehicles.

### Second Embodiment

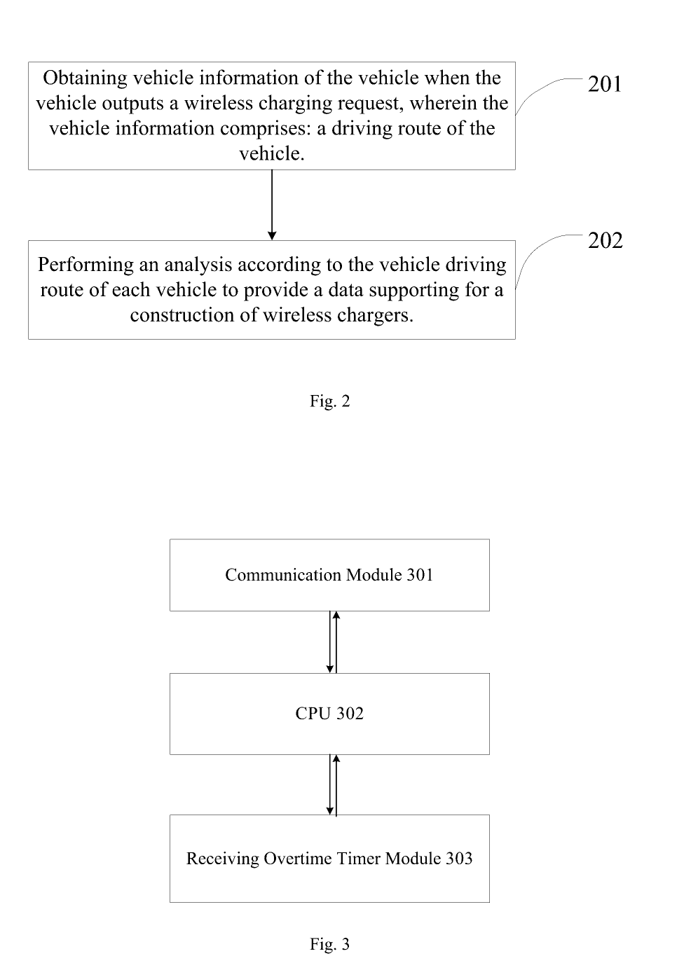

FIG. 2 is the technical flow chart according to second embodiment of the present disclosure. In conjunction with FIG. 2, the present disclosure is a method for wirelessly charging a vehicle based on V2X and achieved by following steps:

Step 201: obtaining vehicle information of the vehicle when the vehicle outputs a wireless charging request; wherein the vehicle information comprises: a driving route of the vehicle.

Step 202: performing an analysis according to the vehicle driving route of each vehicle to provide a data supporting for a construction of wireless chargers.

In the future of city infrastructure construction, the pure road infrastructure construction is not satisfied with the required development of the city. The intelligent roads and intelligent transportation systems gradually become the focus of road construction in city. In one embodiment of the disclosure, it obtains the driving route of the vehicle though a built-in vehicle tracking device and transmits to private network. A large number driving tracks of the vehicle is analyzed by the private network. The analyzed results are referred when building the municipal construction. It can be more reasonable to reconstruct the site as well as choose a site of a wireless charging station, and determine the number of charging devices which simultaneously provide the charging service.

Electronic map data is the basic data of a variety of intelligent transportation system and has great significance for facilitating people to travel as well as solving city traffic congestion. The traditional data updating method of the road network requires a lot of manpower and resources. Therefore, extracting the important information of the road network from other data sources and applying to the intelligent traffic are necessary. When the amount of data of the vehicle driving routes is large sufficiently, it can be used to contracture the road network, update or revise the current road information in the existing map. The mass vehicle tracks obtained becomes possible because of wide use of the vehicle position device. The tracks data is a complete record of vehicle routes. The vast amounts of data constituted by the mass driving routes of the vehicles can be an important data of the electronic map. The vehicle needs to be recharged may search the wireless charging station in the vicinity such as availability, queue status and vehicle model matching status etc. It is possible to avoid charging congestion and improve the charging efficiency. For the road systems, the vehicle driving tracks may help to adjust traffic demand and improve the service capacity and the quality of service. In addition, according to the vehicle driving tracks, charging can be effectively monitored and reminded. For example, the path between home and the office appears frequently in its driving tracks for a user who needs to drive to work every day. This high frequency driving tracks of user is combined and determines whether the power of vehicle is sufficient for user's next driving route so as to provide power monitoring and charging reminder for the user.

### Third Embodiment

FIG. 3 is the schematic diagram for the apparatus according to the third embodiment of the present disclosure. In conjunction with FIG. 3, the present disclosure is an apparatus of wirelessly charging a vehicle based on V2X and composed by two major modules: a V2X communication module 301 and a CPU (Central Processing Unit) 302, wherein the CPU further comprises a receiving overtime timer module 303.

The V2X communication module 301 is configured to obtain vehicle information of the vehicle when the vehicle outputting a wireless charging request; wherein the vehicle information comprises: a unique identification number of the vehicle and a license plate of the vehicle. The CPU 302 connects to the V2X communication module 301 and receives the vehicle information outputted from the V2X communication module 301. The CPU is configured to determine whether the vehicle conforms to a predetermined charging condition according to the unique identification number of the vehicle and the license plate of the vehicle; and receive a wireless charging request command and turning on a charging power source if the vehicle conforms to the predetermined charging condition; wherein the predetermined charging condition comprises a vehicle type and information whether an identify of the vehicle matches with a current wireless charger.

In one embodiment of the disclosure, if the vehicle information comprises a vehicle driving route, the V2X communication module 301 is further configured to perform an analysis according to the vehicle driving route of each vehicle to provide a data supporting for a construction of wireless chargers.

In one embodiment of the disclosure, if the vehicle information comprises a remaining power of the vehicle, the CPU 302 is further configured to wirelessly charge a corresponding power configured on the vehicle according to the remaining power of the vehicle, monitor the remaining power of the vehicle in real time through the V2X communication module, and turn off the charging power source when the remaining power charged full.

The CPU 302 further comprises a receiving overtime timer module 303.

The receiving overtime timer module 303 is configured to turn on the receiving overtime timer module when a wireless charging switch turns on, confirm the success of wireless charging of the vehicle when receiving a success message of wireless charging outputted from the vehicle, and keep the charging power turning on.

In one embodiment of the disclosure, the CPU 302 is configured to turn off the charging power source when it is detected that the current power of the vehicle through the V2X communication module is not charged fully and a stopping charging command is outputted from the vehicle.

The embodiment of the V2X based wireless charging apparatus for vehicles, the communication between the vehicle and the wireless charging station is achieved through the V2X communication module. The vehicle type and identify of the vehicle of each charging requested vehicle is obtained and the CPU determines whether the predetermined charging condition is confirmed. The promotion of wireless charger and the popularity of electric vehicles are promoted. The safety and the efficiency of wireless charger is increased.

### Forth Embodiment

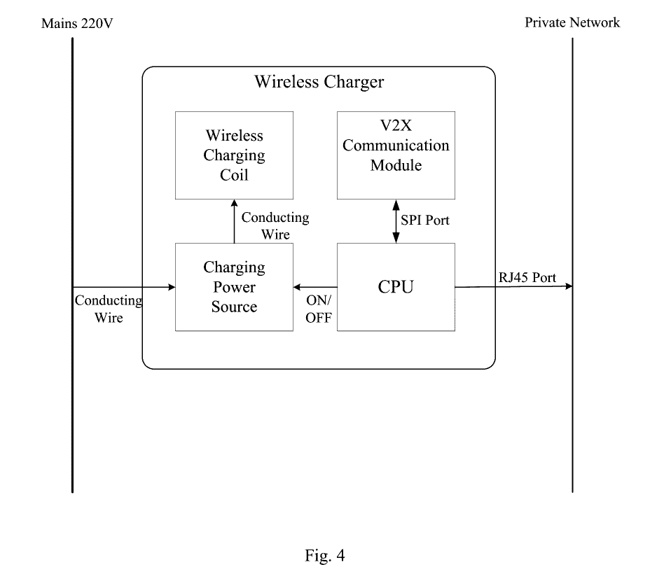

FIG. 4 is a schematic diagram of the interaction between the apparatus and the technical flow chart according to the forth embodiment of the present disclosure. With reference to FIG. 4, the constitution of the embodiment of the V2X based wireless charging apparatus for vehicles not only comprises the V2X communication module and the CPU, but also comprises the following parts according to the functions: a charging power source, a wireless charging coil, a private port (SPI port, RJ45 port), a switch and a conducting wire, wherein the CPU further comprises a receiving overtime timer module. The following will go into details on the interaction between the function of each module and other components of V2X based wireless charging apparatus for vehicles according to the embodiment of the disclosure.

Step 401: a V2X communication module obtains vehicle information of the vehicle when the vehicle outputs a wireless charging request, wherein the vehicle information comprises: a unique identification number of the vehicle and a license plate of the vehicle. The communication module adopted in the embodiment of the disclosure is V2X communication module. V2X module will be a built-in standard modules in the future of electric vehicles with the development of V2X technology. So for the wireless chargers, they also need to install the corresponding V2X communication module. The V2X communication modules in the embodiment of the disclosure are referred to the V2X communication modules installed on the wireless charger. Therefore, the progress of the V2X communication module obtaining information related to the embodiment of the disclosure actually means that the progress of the V2X communication module installed on the vehicle obtains the corresponding vehicle information, transmits the vehicle information to the V2X communication module installed on the wireless charger, and then the V2X communication module installed on the wireless charger transmits to the CPU of the wireless charger.

To be an oncoming vehicle communication technology, V2X (Vehicle to X) is the key technology of the intelligent transportation system in the future. V2X technology is in line with the basic principles of IEEE802.11p communication protocols. The technology is applied on the vehicle electronics and the vehicle communication such that the communication between vehicles and vehicles, vehicles and base stations, or base stations and base stations become feasible. Therefore, the real-time traffic, road information, pedestrian information and other series of traffic information can be obtained. Increasing driver safety, reducing congestion, improving traffic efficiency and providing vehicle entertainment information are achieved.

The vehicle wireless charger in one embodiment of the disclosure, the V2X communication module is in charge of communicating to another V2X communication module disposed on the vehicle. The V2X communication modules obtain the vehicle information according to the related protocols and transmit the vehicle information to another V2X communication module disposed on the wireless charger. Wherein, the vehicle information comprises the unique identification number of the vehicle, the license plate of the vehicle, the remaining power of the vehicle, the safe self-checking of the vehicle and the vehicle driving route, but not limits to.

When the V2X communication module obtains the charging request sent from the vehicle, collects the corresponding vehicle information and transmits the vehicle information to the CPU through the SPI port. Step 402: the CPU determines whether the vehicle conforms to a predetermined charging condition according to the unique identification number of the vehicle and the license plate of the vehicle; and receives a wireless charging request command and turning on a charging power source if the vehicle conforms to the predetermined charging condition; wherein the predetermined charging condition comprises a vehicle type and whether an identify of the vehicle matches with a current wireless charger.

When the CPU receives the vehicle information obtained by the V2X communication module, analyzes the vehicle information to obtain the unique identification number of the vehicle and the license plate of the vehicle. In one application practice of the embodiment of the disclosure, the CPU module of the wireless charger may reserve for some particular license plates allowed to be charged with regards to the private wireless charger. For example, with regards to wireless chargers of one organization, the CPU may reserve license plates of the internal vehicles in the organization. When the vehicle requests for charging, the V2X communication module obtains the license plate of the vehicle and transmits to the CPU. The CPU compares the beforehand reserved license plates. If the license plate conforms to the beforehand reserved license plates, it wirelessly charges the charging requested vehicle. This avoids the loss of private wireless charging facilities on the economy and facilitates the strict management of wireless charger in the organization. To some extent, the security of wireless charging is improved, and the development of electric vehicles is promoted.

It is worth noting that, the CPU wirelessly charge a corresponding power configured on the vehicle according to the remaining power of the vehicle. Further characteristic is achieved by the following steps:

Step 4021: If the vehicle information obtained by the V2X communication module comprises a remaining power of the vehicle, the CPU wirelessly charge a corresponding power configured on the vehicle according to the remaining power of the vehicle.

Specifically, in this step, the V2X communication module 301 communicates to the V2X communication module disposed on the vehicle, and thus obtains the vehicle information.

Step 4022: the CPU turns on a receiving overtime timer when a wireless charging switch is turned on, confirms the success of wireless charging of the vehicle when receiving a success message of wireless charging outputted from the vehicle in the predetermined time, and keeps the charging power turned on. The overtime timer is controlled by the CPU. When the wireless charging switch is turned on, the CPU turns on the overtime timer module. If the vehicle receives the energy from the wireless charging in the normal time range, the V2X communication module disposed on the vehicle transmits the confirmed message of success charging to the CPU through the V2X communication module of the wireless charger. The charging power source controlled by the CPU keeps to turn on. The charging power wirelessly charges the vehicle through the wireless charging coil connected with the conducting wire.

In one embodiment of the disclosure, the charging power source connects to the mains 220V through a conductive wire and transfers the mains to the charging voltage required by wireless charging coil.

Step 4023: the V2X communication module 301 monitors the remaining power of the vehicle in real time. The CPU module 302 turns off the charging power source when the remaining power charged full.

Specifically, in this step, the V2X communication module 301 communicates to the V2X communication module disposed on the vehicle, and thus achieves to monitor the remaining power of the vehicle.

Step 4024: the CPU 301 turns off the charging power source when the V2X communication module 301 detects the remaining power not charged full as well as a stopping charging command outputted from the vehicle.

Specifically, in this step, the V2X communication module 301 communicates to the V2X communication module disposed on the vehicle, and thus detects the remaining power not charged full as well as a stopping charging command outputted from the vehicle.

It is worth noting that, the V2X communication module 301 further obtains the vehicle driving route and transmits the driving tracks of the vehicle to the CPU through the SPI port, then the CPU transmits it to the private network through the RJ45 port. The private network is further configured to provide a data supporting to a construction of wireless charger according to the analysis of the vehicle driving route of each vehicle.

The apparatus embodiments described above are merely illustrative, wherein the unit described as a separate member may or may not be physically separate, and the component shown as a unit may or may not be physical units, i.e., it may be located in one place, or may be distributed to various network elements. Some or all of the modules may be selected to achieve the purpose of the present examples of the embodiments according to the actual need. Those of ordinary skill in the case may understand and implement the disclosure without paying any creative work.

The above description of embodiments, those skilled in the art can clearly understand the various embodiments may be implemented by software plus a necessary universal hardware platform for implementation, and of course, also be implemented by hardware. Based on this understanding, the nature of the technical proposal or the part contributing to the prior art may be embodied in the form of a software product. The computer software product may be stored in a computer readable storage medium, such as ROM/RAM, magnetic disc, CD-ROM, including several instructions to instruct a computer device (a personal computer, a server, or a network equipment) to perform the method described in some parts of the various embodiments or examples.

Finally, it should be noted that the above embodiments are merely provided for describing the technical solutions of the disclosure, but not intended to limit the disclosure. Although reference to the embodiments of the disclosure has been described in details, those skilled in the art will appreciate that the technical solutions described in the foregoing embodiments can be modified, or equivalently replaced for some technical features; and such modifications or replacements do not make the essence of the corresponding technical solutions depart from the spirit and scope of the technical implementation of the disclosure.

What is claimed is:

1. A method for wirelessly charging a vehicle based on V2X, comprising:
obtaining vehicle information of the vehicle when the vehicle outputs a wireless charging request, wherein the vehicle information comprises: an unique identification number of the vehicle and a license plate of the vehicle; and
determining whether the vehicle conforms to a predetermined charging condition according to the unique identification number of the vehicle and the license plate of the vehicle; and receiving a wireless charging request command and turning on a charging power source if the vehicle conforms to the predetermined charging condition, wherein the predetermined charging condition comprises a vehicle type and information whether an identify of the vehicle matches with a current wireless charger.

2. The method of claim 1, wherein the vehicle information comprises a vehicle driving route;
wherein the method further comprises: performing an analysis according to the vehicle driving route of each vehicle to provide a data supporting for a construction of wireless chargers.

3. The method of claim 1, wherein the vehicle information comprises remaining power of the vehicle;
wherein the receiving the wireless charging request command outputted from the vehicle and turning on the charging power source further comprises:
wirelessly charging a corresponding power configured on the vehicle according to the remaining power of the vehicle; monitoring the remaining power of the vehicle in real time; and turning off the charging power source when the remaining power charged full.

4. The method of claim 3, wherein the receiving the wireless charging request command outputted from the vehicle and turning on the charging power source further comprises:
turning on a receiving-overtime timer when a wireless charging switch is turned on; and confirming that the vehicle has been wireless charged successfully and keeping the charging power to be turned on when it is determined to receive a message of successfully wirelessly charging outputted from the vehicle.

5. The method of claim 3, wherein the monitoring the remaining power of the vehicle in real time further comprises:
turning off the charging power source when it is detected that the current power of the vehicle is not charged fully and a stopping charging command is outputted from the vehicle.

6. An apparatus of wirelessly charging a vehicle based on V2X, comprising:
a V2X communication module configured to obtain vehicle information of the vehicle when the vehicle outputs a wireless charging request, wherein the vehicle information comprises: a unique identification number of the vehicle and a license plate of the vehicle; and
a CPU configured to determine whether the vehicle conforms to a predetermined charging condition according to the unique identification number of the vehicle and the license plate of the vehicle; and receiving a wireless charging request command and turning on a charging power source if the vehicle conforms to the predetermined charging condition, wherein the predetermined charging condition comprises a vehicle type and information whether an identify of the vehicle matches with a current wireless charger.

7. The apparatus of claim 6, wherein the vehicle information comprises a vehicle driving route; and the CPU is further configured to perform an analysis according to the vehicle driving route of each vehicle to provide a data supporting for a construction of wireless chargers.

8. The apparatus of claim 6, wherein the vehicle information comprises a remaining power of the vehicle; the CPU is further configured to wirelessly charge a corresponding power configured on the vehicle according to the remaining power of the vehicle, monitor the remaining power of the vehicle in real time, and turn off the charging power source when the remaining power is charged full.

9. The apparatus of claim 8, wherein the CPU further comprises a receiving overtime timer module configured to turn on the receiving overtime timer module when a wireless charging switch turned on, confirm that the vehicle has been wireless charged successfully and keep the charging power to be turned on when it is determined to receive a message of successfully wirelessly charging outputted from the vehicle.

10. The apparatus of claim 8, wherein the CPU is further configured to turn off the charging power source when it is detected that the current power of the vehicle is not charged fully and a stopping charging command is outputted from the vehicle.
